(19) United States
(12) Patent Application Publication
(10) Pub. No.: US 2026/0292884 A1
(43) Pub. Date: Sep. 24, 2026

(54) METHODS, ARCHITECTURES, APPARATUSES AND SYSTEMS FOR RELIABILITY HANDLING OF AMBIENT INTERNET OF THINGS

(71) Applicant: InterDigital Patent Holdings, Inc., Wilmington, DE (US)

(72) Inventors: Martino Freda, Laval (CA); Paul Marinier, Brossard (CA); Erdem Bala, East Meadow, NY (US); Kevin Wanuga, Souderton, PA (US); Jongwoo Hong, New York, NY (US); Patrick Tooher, Montreal (CA)

(21) Appl. No.: 19/087,834

(22) Filed: Mar. 24, 2025

(51) Int. Cl. H04W 74/0833; H04W 24/02; H04W 68/02

(52) U.S. Cl. CPC H04W 74/0833; H04W 24/02; H04W 68/02

(57) ABSTRACT

Procedures, methods, architectures, apparatuses, systems, devices, and computer program products are disclosed and described. A wireless transmit-receive unit, WTRU, receives configuration information comprising conditions related to a service request. It receives a service request comprising at least one parameter relating to the conditions. It determines a transaction identifier based on the service request and transmits a paging message for triggering a random access, RA, of devices. The paging message includes an indication of resources to use for RA and the transaction identifier. The WTRU receives and collects data from the devices that successfully performed RA in the indicated resources. For collecting data from the devices that did not successfully perform RA in the indicated resources, the WTRU repeats, according to the conditions, transmitting the paging message and receiving and collecting the data. Finally, the WTRU reports, to the network, the collected data.

### INCORPORATION BY REFERENCE

The following documents are incorporated by reference in their entirety: 3GPP TSG RAN Meeting #102, RP-234058, Dec. 15, 2023, “Study on Solutions for Ambient IoT (Internet of Things) in NR”; 3GPP TR 38.769 V2.0.0, December 2024, “Study on solutions for ambient IoT (Internet of Things)”; and GS1 EPCGLOBAL, EPC Radio-Frequency Identity Protocols Generation-2 UHF RFID, Specification for RFID Air Interface, Protocol for Communications at 860 MHz-960 MHz Version 2.0.1 Ratified, April 2015.

### BACKGROUND

The present disclosure is generally directed to the fields of reliability handling of ambient IOT (AIOT).

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a sequence chart of an inventory procedure;

FIG. 3A-D are exemplary network topologies;

FIG. 4 is a sequence chart of an AIOT random access framework;

FIG. 5 is an architecture of an AIOT device;

FIG. 6 is a flow chart of a method 600 for determining a number of paging rounds to initiate for an inventory service request; and

FIG. 7 is a flow-chart of a method 700 according to an embodiment.

### DETAILED DESCRIPTION

### Abbreviations and Acronyms

| | |
|---|---|
| 5G/6G | Fifth/Sixth-Generation |
| AC | Alternate Current |
| AIOT/AIoT | Ambient Internet of Things |
| | (protocol for AIoT devices specified by 3GPP) |
| AS | Access Stratum |
| BB | Broad Band |
| BPF | Band-Pass Filter |
| BS | Base Station |
| BSR | Buffer Status Reporting |
| CBRA | Content-Based Random Access |
| CN | Core Network |
| CRC | Cyclic Redundancy Check |
| C-RNTI | Cell Radio Network Temporary Identifier |
| DC | Direct Current |
| DCI | Downlink Control Information |
| DL | Downlink |
| DO-A | Device-Originated Autonomous |
| FDM | Frequency Division Multiplexing |
| HO | Hand Over |
| IAB | Integrated Access and Backhaul |
| ID | Identifier |
| I-RNTI | Interactive RNTI |
| LPF | Low-Pass Filter |
| LSB | Least-Significant Bit |
| MAC CE | Media Access Control - Control Element |
| NACK | Non-Acknowledge/Not-Acknowledged |
| MSG | Message |
| NR | New Radio |
| NW | Network |
| PMU | Power Management Unit |
| QoS | Quality of Service |
| R2D | Reader-to-Device |
| RACH | Random Access Channel |
| RF | Radio Frequency |
| RFID | Radio Frequency Identification |
| | (a protocol for communication with RFID |
| | devices that is not specified by 3GPP) |
| RLF | Radio Link Failure |
| RNTI | Radio Network Temporary Identifier |
| RRC | Radio Resource Control |
| SDT | Small Data Transmission |
| SIB | System Information Block |
| S-TMSI | S-Temporary Mobile Subscriber Identity |
| TAG | RFID/AIoT tag, RFID/AIoT device |
| UE | User Equipment |
| UL | Uplink |
| WTRU | Wireless Transmit-Receive Unit |

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

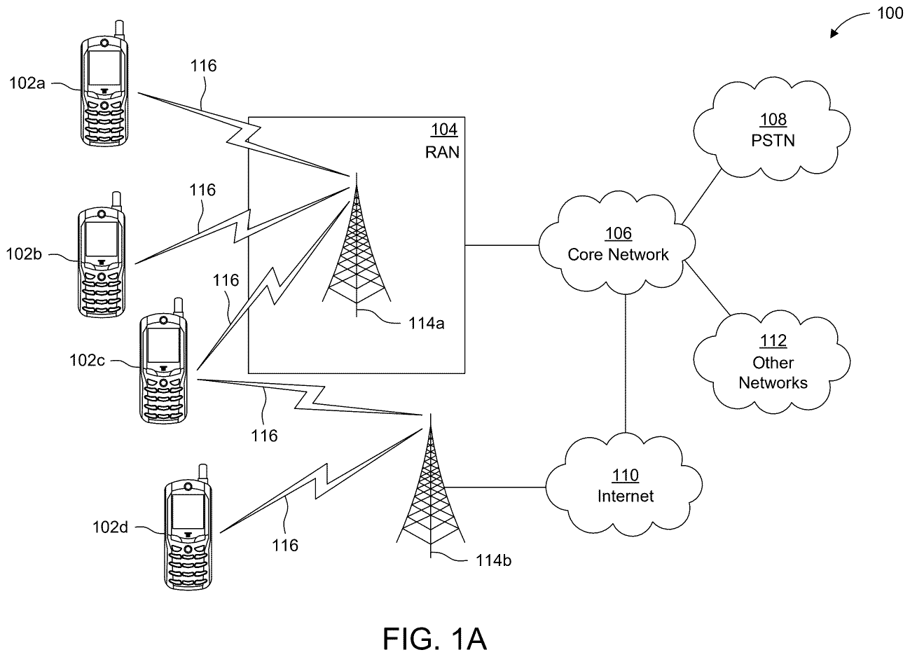

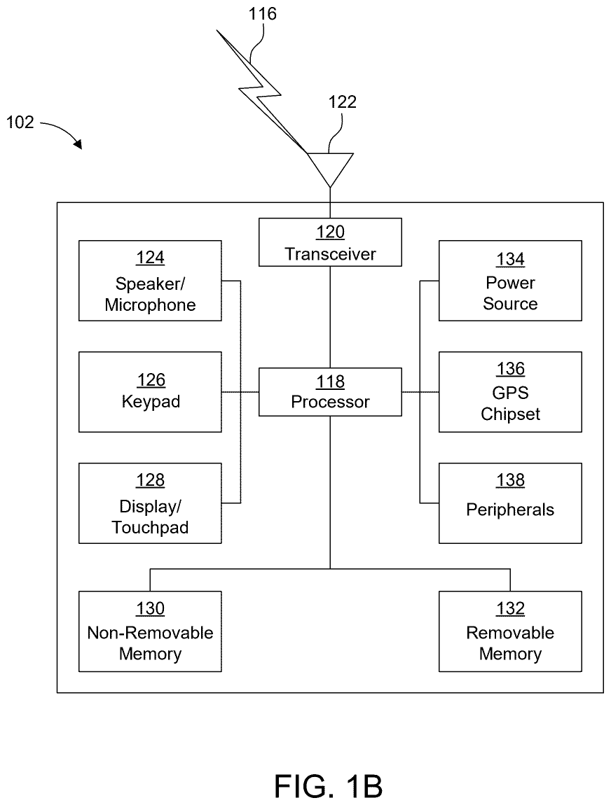

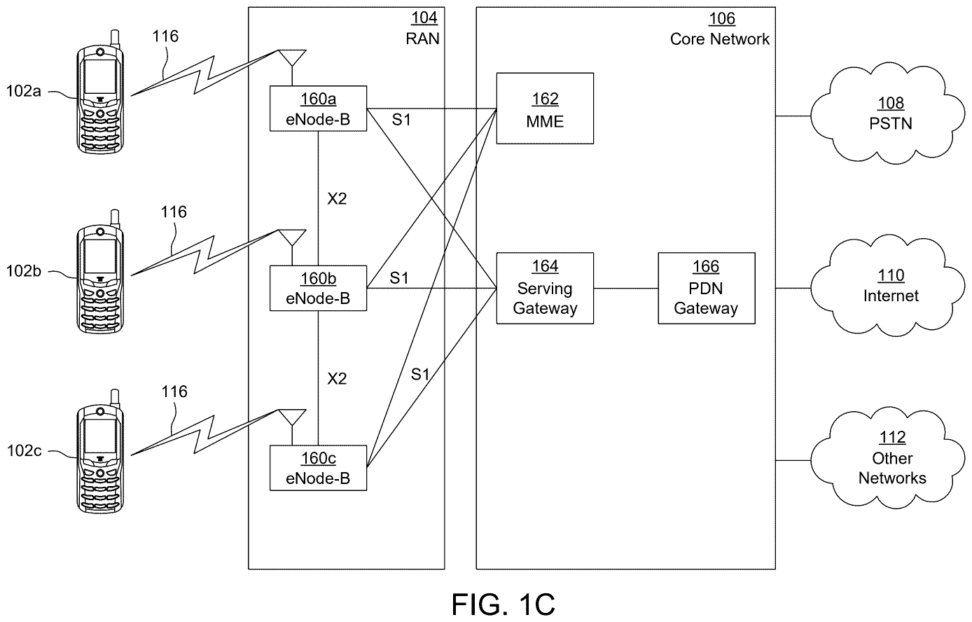

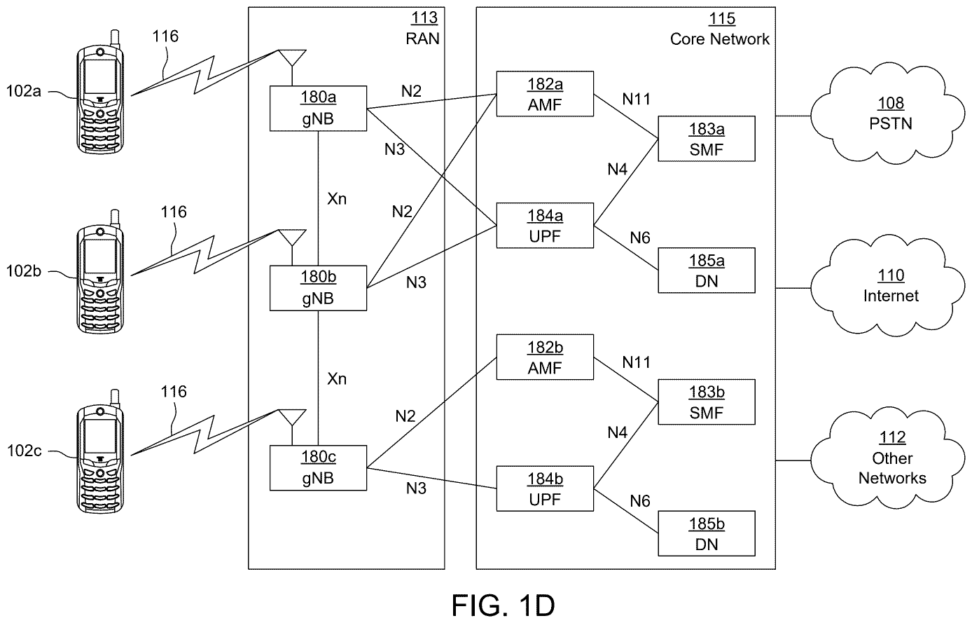

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### AIOT Study in Release 19 of 3GPP RP-234058

3GPP has agreed to a study item on AIoT in Release 19. Justification for this study item has come from the increased popularity of IoT. In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is impossible to power all the IoT devices by battery that needs to be replaced or recharged manually, which leads to high maintenance cost, serious environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from luW to a few hundreds of μW. Existing cellular devices may not work well with energy harvesting due to their peak power consumption of higher than 10 mW.

### RFID Procedures

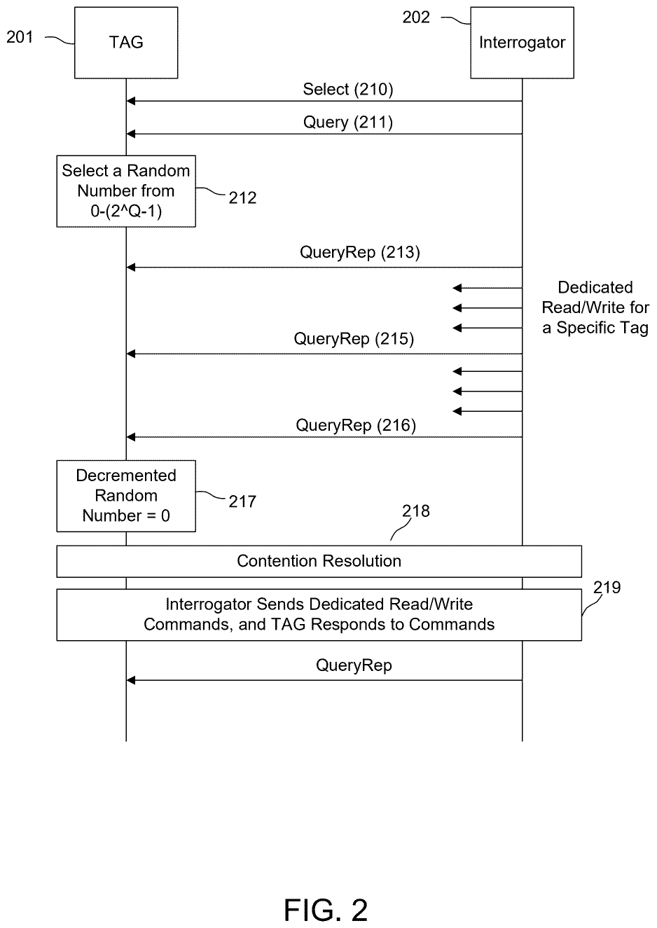

RFID is usually used currently for applications of asset identification. An RFID inventory procedure is shown in FIG. 2. Note that in the figure, ‘QueryRep’ means a repetition of ‘Query’.

In the inventory procedure, an Interrogator 202 sends a Query message to energize all or a subset of TAGs. Following a Query message, a TAG 201 of the subset of TAGs selects a random number from 0-2\hat{ }Q−1 and loads its memory with that number. At each transmission of a QueryRep (213, 215, 216), the TAG decrements its counter until the counter reaches 0. When the counter reaches 0, the TAG initiates a contention resolution procedure (218) which consists of transmitting its device ID in the uplink, and waiting for confirmation of the device ID in the downlink (to address possible collision between multiple devices selecting the same random number). For a device that has passed contention resolution, the interrogator can send multiple read/write commands (219), to which the TAG should respond.

### AIOT Topologies

### Topology 1: BS↔Ambient IoT Device

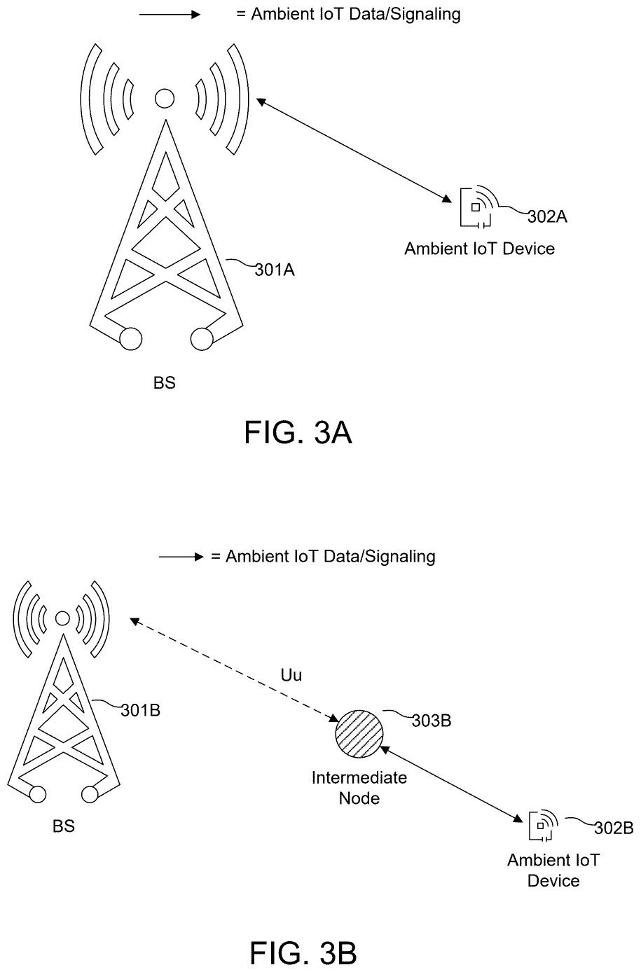

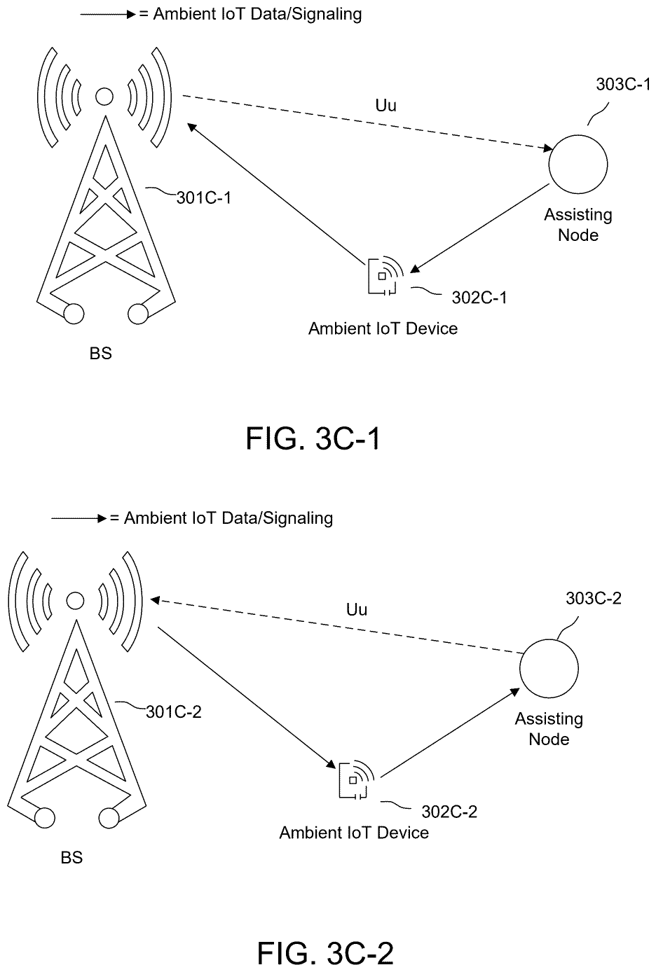

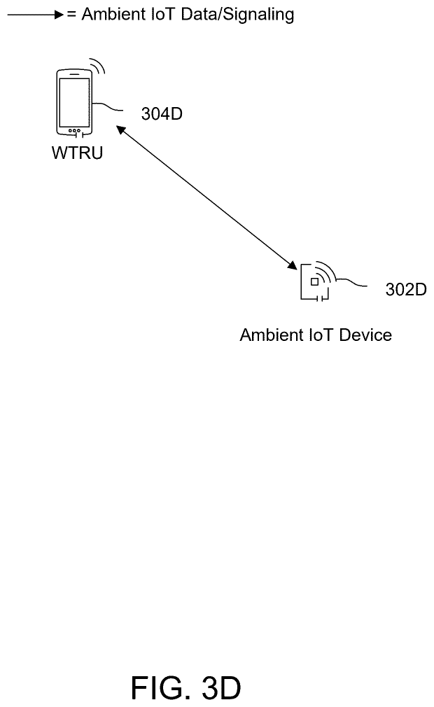

See FIG. 3A. In a first topology ‘Topology 1’, the Ambient IoT device (302A) directly and bidirectionally communicates with a base station (BS, 301A). The communication between the base station and the ambient IoT device includes Ambient IoT data and/or signalling. This topology includes the possibility that the BS transmitting to the Ambient IoT device is a different from the BS receiving from the Ambient IoT device.

### Topology 2: BS↔Intermediate Node↔Ambient IoT Device

See FIG. 3B. In a second topology ‘Topology 2’, the Ambient IoT device (302B) communicates bidirectionally with an intermediate node (303B) between the device (302B) and base station (301B). In this topology, the intermediate node can be a relay, IAB node, WTRU, repeater, etc. which is capable of Ambient IoT. The intermediate node transfers the information between BS and the Ambient IoT device.

### Topology 3: BS↔Assisting Node↔Ambient IoT Device↔BS

See FIG. 3C. In a third topology ‘Topology 3’, the Ambient IoT device (302C-1) transmits data/signalling to a base station (301C-1), and receives data/signalling from the assisting node (303C-1); or the Ambient IoT device receives data/signalling from a base station and transmits data/signalling to the assisting node. In this topology, the assisting node can be a relay, IAB, WTRU, repeater, etc. which is capable of ambient IoT.

### Topology 4: WTRU↔Ambient IoT Device

See FIG. 3D. In a fourth topology ‘Topology 4’, the Ambient IoT device (302D) communicates bidirectionally with a WTRU (304D). The communication between WTRU and the ambient IoT device includes Ambient IoT data and/or signalling.

### AIOT Random Access Framework

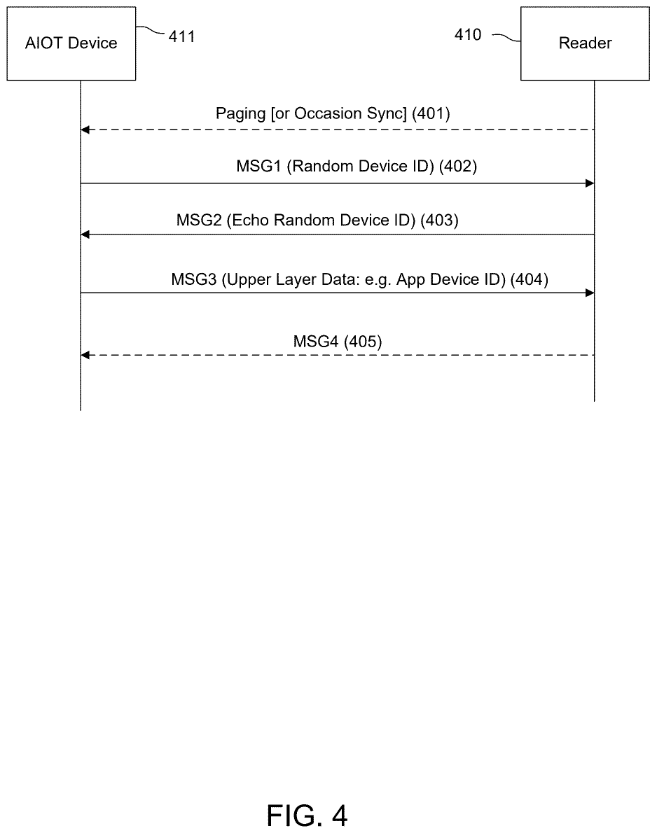

A sequence chart showing the AIOT random access framework is shown in FIG. 4.

In 401, a reader (410) sends a paging message and a set of occasion synchronization messages which respectively provides the device IDs of the devices to respond and configures/delimits the random access occasions for transmissions by the AIOT devices.

In 402, an AIOT device (411) selects an occasion (using at least slotted ALOHA as the baseline; slotted ALOHA is a well known random access protocol used by early computer networks), and transmits a random device ID in MSG1. Note that similar to Uu, random access in AIOT is characterized by a set of messages transmitted by the two entities (in this case the device and the reader) which are numbered MSG1-4.

In 403, the reader, upon successful reception of MSG1, transmits MSG2 by including the received random device ID in MSG2.

In 404, if the AIOT device received the echoed random device ID in MSG2, it transmits MSG3 which contains upper layer data (e.g., an application layer device ID).

In 405, MSG4 may be transmitted by the reader (e.g., for subsequent command transmission), but the understanding is that contention is already resolved at MSG2 transmission.

Paging for CBRA includes a group ID (indicating a group of devices, or all device) that is generated by upper layers and a number of access occasions. Time domain access occasions are indicated by another message (“occasion sync”) which can be a separate R2D message, or could re-use the paging message.

MSG4 is NACK based (i.e., reader sends NACK if MSG3 fails in order to trigger re-access in the failed device).

### AIOT Device Architecture

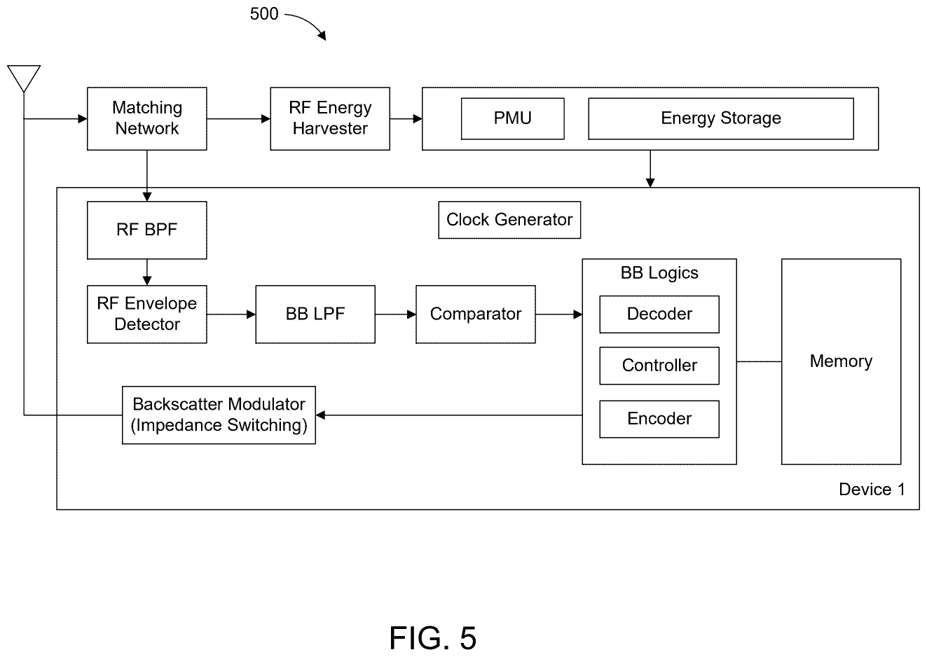

A typical AIOT device (500) architecture is shown in FIG. 5. In the figure:

The antenna may be either shared or separate for RF energy harvester and receiver/transmitter.

Matching network is to match impedance between antenna and other components (including RF energy harvester and receiver related blocks).

RF energy harvester can include rectifier performing RF signal (AC) to DC conversion.

Energy storage (e.g., capacitor) stores harvested energy from RF energy harvester.

Power management unit (PMU) manages storing energy to energy storage from energy harvester and supplying power to active component blocks which needs power supply.

Digital BB logic includes functional blocks like encoder, decoder, controller, etc.

Memory can include two types of memory: 1) Non-Volatile Memory (NVM) such as EEPROM for permanently storing device ID, etc, and 2) registers for temporarily keeping any information required for its operation only while energy is available in energy storage.

Clock generator provides required clock signal(s).

### Reception Related Blocks:

RF BPF for improving selectivity. Depending on implementation, it may not exist. RAN4 RF requirement (if any, e.g., ACS) and peak power consumption target also need to be considered.

RF Envelope Detector converts RF signal to baseband.

BB LPF can filter out harmonics and high frequency components to improve input signal quality to comparator. Depending on implementation, it may not exist.

Comparator determines high/low of input signal.

### Transmission Related Blocks:

Backscatter modulator switches impedance to modulate backscattered signal with transmitted signal from BB logic.

### Paging Repetition

Inventory robustness (e.g., achieving inventory of devices which may miss or fail a given paging procedure) can be achieved by the reader repeating the paging procedure for the same inventory service request. In order to achieve robustness of inventory without sacrificing device power consumption, a “transaction ID” ID can be included in the paging message transmitted by the reader:
The reader may repeat a paging message multiple times for the same service request from the CN so that devices which failed to respond to one paging can respond to the next paging message;
The reader may include a transaction ID in the paging message so the device can differentiate “subsequent paging” (and respond only to a subsequent paging message comprising a same transaction ID if it has not previously responded successfully).

In topology 1, the reader represents a network node, and the network may control the number of repetitions needed to achieve a required reliability. In topology 2, the reader may use resources allocated by the network. For an efficient use of network resources, the number of redundant requests (i.e. paging procedures corresponding to the same service request) may be limited and may be based on resource availability. Specifically, repetition of a paging round can be expensive in terms of resources and signaling. Especially for topology 2, where the network may be allowed to control the resources, the paging retransmission performed by the reader WTRU may be controlled. It may then be determined whether subsequent paging may be used by the reader for the same service request.

Common Terminology and Concepts Used Throughout this Document

The following terminology is used and can be assumed throughout this disclosure.

### Device Terminology

In this document, the terms ‘device’, ‘AIOT WTRU’, ‘TAG’ may be used interchangeably to mean the AIOT device that is being inventoried/queried by the reader.

The term ‘reader’ refers to the entity which queries the AIOT device, either directly, or via an intermediate WTRU in topology 2. In topology 2, the term ‘reader’ may also refer to the intermediate WTRU. As a result, the term ‘reader’ may refer to a network node or a WTRU, depending on the context and/or the topology.

In this document, the terms reader, network, intermediate WTRU, may be used interchangeably to mean the reader.

### Inventory Terminology

In this document, ‘inventory’ refers to the overall procedure of a reader triggering access to the resources of the RAN by multiple AIOT devices using a sequence of messages (e.g., similar to query, followed by query rep (short for query repetition) in RFID). Specifically, the inventory procedure refers to a single round of attempts to have each device respond or attempt to respond with its access ID, or perform a RACH procedure. Specifically, the inventory procedure refers to a set of access occasions which may have 0 or at least 1 device respond within the access occasion.

An inventory procedure may occur similar to legacy RFID procedure. Although referred to herein as inventory procedure, it may be termed differently in device requirements or specifications (e.g., query procedure, paging procedure, etc).

### Occasion Terminology

In this document, ‘occasion’ refers to the opportunity for device transmission that may be delimited by the transmission of a query rep message (or similar). Specifically, a device may perform transmission in an occasion by performing a AIOT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever embodiments indicate selection of an occasion, they can apply equivalently to selection of only a time component and/or selection of a frequency component.

### Time Reference

Herein, depending on the embodiment or description, any reference to time may be associated with an absolute time measurement (e.g., seconds, slots, frames, etc). Alternatively, it may refer to a number of executions of a procedure, possibly triggered by a reader (e.g., number of inventory procedures, number of accesses or RACH procedures, etc). Alternatively, it may refer to a number of messages, possibly of a specific type, or containing specific information, as described herein, received or transmitted.

### DO-A Terminology

Herein, ‘DO-A traffic’ or ‘DO-A data’ refers to data transmitted by an AIOT device to an AIOT reader as a result of a device autonomously generating the data and indicating the need to send such data. Such data may be generated asynchronously or in a non-predictable (by the reader) pattern or timing. However, embodiments herein which refer to DO-A traffic may not be limited to such type of traffic alone any may apply to any data transmitted from the device to the reader.

### Transaction ID Determination

A transaction ID may consist of any information transmitted in the paging message by the reader WTRU and used by a device to determine whether to respond to a subsequent paging message when it responded successfully to a previously received paging message.

Conditions Associated with Performing “Transaction ID Behavior”

In each of the embodiments in this section, a WTRU may perform one of the actions associated with transaction ID behavior described in such embodiment (e.g., reporting the transaction ID to the network, including a reader-defined portion for the transaction ID in the paging message, falling back to a default value of the transaction ID, etc.), based on one or more of the following conditions:
Condition: measurements of a received message(s) from one or more devices. For example, the WTRU may perform “transaction ID behavior” if the received power of a D2R message is below a threshold, possibly for a specific device (e.g., a device having an ID provided by the network for which the reader should behave accordingly);
Condition: Information about the service received from the network.

Such information may be related to the QoS, and a condition could be defined based on the QoS. For example, the WTRU may receive a QoS value or QoS marking associated with a service request, and may perform “transaction ID behavior” when the value corresponds to one or a specific subset of values. For example, the WTRU may receive a maximum latency and may perform “transaction ID behavior” if the latency is above or below a threshold;
Such information may be related to the type of service. For example, the WTRU may perform “transaction ID behavior” for an inventory procedure but not for inventory+command, or command only. For example, the WTRU may perform “transaction ID behavior” only when the service ID type is a configured or predefined value. For example, the WTRU may perform “transaction ID behavior” only when the service being initiated is related to localization.

Such information may be related to the number of devices. For example, the WTRU may perform “transaction ID behavior” when the service is for one device. For example, the WTRU may perform “transaction ID behavior” when the service is for more than one device. For example, the WTRU may perform “transaction ID behavior” when the service for at most or at least a configured number of devices

Such information may be related to the device IDs to be included in the paging message.

For example, the WTRU may perform “transaction ID behavior” when the IDs provided in the service request are permanent IDs. For example, the WTRU may perform “transaction ID behavior” when the IDs provided in the service request are temporary IDs. For example, the WTRU may perform “transaction ID behavior” when the IDs provided is in the form of a group ID. For example, the WTRU may perform “transaction ID behavior” when the IDs provided is in the form of individual device IDs.

### Condition: RRC State of the WTRU

For example, the WTRU may perform “transaction ID behavior” only when the reader WTRU is in a specific RRC state. For example, it may perform “transaction ID behavior” in RRC_CONNECTED only. For example, the WTRU may perform “transaction ID behavior” upon each transition to RRC_CONNECTED state.

### Condition: Mobility of the Reader WTRU

For example, the WTRU may perform “transaction ID behavior” upon a mobility event (e.g., HO, cell reselection, reestablishment, etc.). For example, the WTRU may perform “transaction ID behavior” upon the first service request triggered following a mobility event

### Condition: Time Elapsed for an Inventory Procedure

For example, the WTRU may perform “transaction ID behavior” if an inventory lasts longer than a configured threshold, longer than an indicated time (e.g., energy duration provided by a device), etc.

### Reader Determines a Transaction ID Associated With Each Paging Transmission for a Service

A reader WTRU may determine a transaction ID to be included in a paging message. The reader may include the same transaction ID value in each paging message associated with paging for the same service (e.g., inventory service). For example, as long as the paging is being performed to trigger random access by devices for the same service (e.g., paging repetition for a specific inventory procedure), the reader may use the same value of the transaction ID in each such paging message. A reader WTRU may further perform any of these examples (possibly versus performing another example) only upon a condition associated with performing “transaction ID behavior”, as described herein. The reader WTRU may determine the transaction ID to be used based on one or a combination of the following:

Use a value derived from an ID associated with the specific service request received from the CN. For example, a WTRU may determine the ID using an ID or value provided by the CN (e.g., the service ID corresponding to a service request). The WTRU may use the entire ID, or may use a subset of bits of the received ID as the transaction ID (e.g., X LSBs of the received service ID)

Herein, service ID can be used interchangeably to mean either the entire service ID, or a subset of the bits (e.g., X LSBs) of the service ID. For example, a WTRU may use a function of the service ID or subset of the service ID (e.g., service ID+1, service ID+x) where x may be provided to the network, may be derived by the WTRU, etc. using methods herein, and may be assumed to be unique: for example, a WTRU may be configured with a WTRU specific value or number x, and may determine the transaction ID to be the service ID+x, a subset of bits of the service ID+x, or a subset of the bits of (the service ID+x).

Use a determined value (e.g., based on a counter), possibly under certain conditions, for example, the reader may use a distinct value of the transaction ID for each distinct service request received from the network. For example, the reader may increment the transaction ID from the previously used transaction ID upon reception (or when initiating paging for) a new service request. If a new service request is not received, each paging message may maintain the same transaction ID.

Use an explicit value indicated by the network, possibly under certain conditions, for example, the reader may use an explicit value of the transaction ID provided by the network (e.g., in an RRC message, in SIB, etc.). For example, the reader may use the cell ID, or a portion of the cell ID, provided by the reader. For example, the reader when receiving an explicit value indicated by the network, may use such value as the reader ID. For example, the reader may include, as part of the transaction ID, a value read from system information, or a value received in an RRC message, MAC CE, DCI etc.

Use a default value, possibly under certain conditions, for example, a default value of the transaction ID can be configured or specified, and the WTRU may use such default value, possibly upon a condition associated with performing “transaction ID behavior”, as described herein.

Use a value associated with an ID unique to the reader WTRU, possibly under certain conditions, for example, the WTRU may use part (e.g., a number of LSBs) or all of its C-RNTI, I-RNTI, S-TMSI, etc.

Use a random value (i.e., number of bits)

Use a static reader WTRU identity provided by the network (e.g., provided to the reader when the reader connects to the network to initiate reader behavior) or another reader-unique value

A reader may determine whether to use a reader determined ID (determined using methods described herein) or the service ID, where such determination may be based on conditions associated with performing “transaction ID behavior”.

A reader may derive a transaction ID by combining a value derived from the service request (as per above) in addition with an ID determined by the reader. Specifically, the reader may append a reader determined value to the service request ID or subset of the service request ID. For example, the reader may append reader determined value to the service ID, possibly only under certain conditions described herein. For example, any of the determined value, default value, or explicit value, and the conditions where such are used, can be used to determine the reader portion of the transaction ID and appended to the service ID.

In an embodiment, a reader may, when combining values derived from the service request in addition with an ID determined by the reader, take a subset of each of these portions so that the transaction ID is always the same size, regardless of whether a first or second condition associated with performing “transaction ID behavior” is met. For example, if localization is not requested, the WTRU may use the X LSBs of the service ID as the transaction ID. If localization is requested, the WTRU may use the ‘X-n’ LSBs of the service ID, and add n bits of a reader ID or reader generated value to obtain the X bit transaction ID. Such embodiment may be used for all examples associated with using, as the transaction ID, a combination of values in one case, while using a single value in another. The advantage of such embodiment is to ensure that different readers generate different transactions IDs in the case where localization is requested by the network.

Example embodiments for enabling different response behavior for the multi-reader environment consist of selectively controlling whether a device responds to the same service for multiple readers by proper use of the transaction ID.

In one example embodiment, a reader may receive a service request along with an indication of whether localization is required by the network. In such embodiment, the reader may determine the transaction ID as in the following examples, depending on whether localization is required or requested by the network (e.g., in an RRC message, a MAC CE, a DCI, etc.):
If localization is required, the reader may use a combination of (possibly a subset) of the service ID and a reader generated ID, otherwise, the reader may use only (possibly a subset) of the service ID;
If localization is required, the reader may use an explicit ID provided by the network, and when localization is not required the reader may use a subset of the service ID;
If localization is required, the reader may use a combination of (possibly a subset of) the service ID and a first fixed value (e.g., a bit string with value x, a single bit with value 1, etc.), while if localization is not required, the reader may use a combination of (possibly a subset of) the service ID and a second fixed value (e.g., a bit string with value y, a single bit with value 0, etc.);
If localization is required, the reader may add a configured value to the service ID and use it as the transaction ID, otherwise, the reader may use only the service ID;
If localization is required, the reader may set the transaction ID as the concatenation of a first indication (e.g., ‘0’), a reader ID, and a service ID. If localization is not required, the reader may set the transaction ID as the concatenation of a second indication (e.g., ‘1’), a reader ID, and a service ID;
If localization is required, the reader may set the transaction ID as the service ID+reader specific value (modulo N—to keep the number of bits fixed). If localization is not required, the reader may set the transaction ID as the service ID.

### Reader is Asked to Report the Transaction ID to the Network

Transaction ID coordination between different reader WTRUs for a given service (e.g., the same service from the network) may be required to control whether the device responds to the same service from multiple readers.

According to embodiments, for the case where the reader determines its own transaction ID, a reader may report the transaction ID to the network. For example, the network may provide the reported transaction ID to other reader WTRUs to be used.

In one example, the reader may be requested by the network to report the transaction ID (e.g., with an RRC message, a MAC CE, DCI). For example, the WTRU may receive an inventory request (e.g., in an RRC message), or the AIOT resources to be used to performed the paging procedures associated with the inventory request, which may contain an explicit indication of whether to report the transaction ID to the network or not. The reader may determine a transaction ID to be used in the paging message(s) associated with the inventory request and may provide the determined transaction ID to the network (e.g., in an UL RRC message, UL MAC CE, etc.).

In one example, the reader may report the determined transaction ID based on one or a combination of any of the conditions for performing transaction ID behavior described above.

A WTRU may trigger an RRC connection, an access procedure, a data transmission procedure (e.g., SDT) etc. upon determining the need to report the transaction ID to the network.

Actions Associated with Triggering Re-Access of a Device
Reader Determines an Action Associated with Re-Access

Conditions described herein may be associated with determining whether the reader WTRU should perform one or more actions associated with triggering re-access of one or more devices involved in an AIOT procedure triggered by the reader. Such actions may consist of any (or a combination) of the following:

Determining whether to retransmit a paging message to initiate a new paging round. For example, based on conditions herein, following transmission of a previous paging message to initiate a paging round, and possibly following completion of the paging round, a reader may determine, based on one or more conditions, whether to retransmit a paging message for the same service. Such may consist of, for example, re-using the same transaction ID in the paging message.

Determining the number of paging retransmissions associated with a single service. For example, upon reception of a service request from the network, the reader may determine a number of paging transmissions or paging rounds, possibly associated with the same service request, possibly using the same transaction ID in the paging message

Determine a range for the number of paging retransmissions associated with a single service. For example, the reader may determine a maximum and/or minimum number of allowed paging retransmissions for the same service.

Determine whether to initiate a resource request. For example, initiation of an additional paging round for the same service may require requesting resources from the network, and the reader WTRU may be configured with conditions for triggering a resource request (e.g., transmission of an RRC message, MAC CE, BSR, etc. to the network).

Determining whether to trigger a new paging round prior to completion of a previous paging round. For example, the reader may determine to transmit a paging message to initiate a new paging round prior to the completion of a previously initiated paging round. For example, the reader may announce a first paging round containing N access occasions, and prior to the transmission of the Nth sync messages announcing the Nth access occasions of a paging round, the reader may transmit a paging message initiating a new paging round.

Determining whether to transmit MSG2 following MSG3 transmission by a device (i.e., trigger retransmission of MSG3 by that device) or transmit NACK indication (i.e., trigger re-access by that device).

Determining a number of resources (e.g., time/frequency resources, access occasions, etc.) allowed for a specific paging round, possibly associated with paging retransmission for a given service.

Reader Determines Conditions for Deciding to Perform an Action Associated with Paging

A reader may use any of the following conditions to determine whether to perform an action associated with device re-access.

Conditions related to the number of or detection of MSG3 failures or data transmission (e.g., command response) failures, possibly in a single access round, a number of access rounds, the access rounds to a certain time, etc.:
MSG3/data transmission failure may consist of the reader not receiving MSG3/data transmission in a resource which was indicated to a device (e.g., using MSG2 or command request) which is expected to transmit MSG3/data in the resource;
MSG3/data transmission failure may consist of receiving MSG3/data from a device in error (e.g., CRC check failure);
For example, this (the above mentioned conditions related to the number of or detection of MSG3 failures or data transmission failures) may consist of detection of such failure, determination that number of failures is above a threshold, determination that the number of failures is larger/smaller than in a previous attempt, determination that a specific device has a failure and another does not, determination that the number of consecutive failures is larger than a threshold, etc.

Conditions related to the signal properties of transmissions from devices transmitting in a given paging round. For example, such may consist of:
At least one MSG1 transmission, MSG3 transmission, command response, etc. received with energy above a threshold;
Measured energy in a resource allocated for any of the above transmissions above/below a threshold.

Conditions related to the number of successful device responses in a paging round or a single or multiple access occasions:
This may consist of the number of received MSG3/data transmissions;
This may consist of the number of received MSG1 transmissions.

### Conditions Related to the Service Type:

For example, this may consist of whether one or more devices have a command message pending following the inventory;
For example, this may consist of whether the inventory has been triggered with the purpose of localization.

### Conditions Related to the Number of Remaining Resources:

This may consist of whether the reader WTRU has been provided sufficient resources or not, possibly to trigger a new paging round;
This may consist of whether the remaining resources provided to the reader WTRU is larger than a specific amount.

### Conditions Related to an Elapsed Period of Time:

This may consist of a period of time since the transmission of the last paging message, possibly associated with a specific service;
This may consist of a period of time since the transmission of the first paging message associated with this service request.
   Conditions Related to Whether a Specific Command has been Issued to a Responding Device or not:
For example, this may consist of whether the reader has a pending command to be issued associated with a service request;
For example, this may consist of whether the reader has issued any commands to devices at a specific time.

### Conditions Related to the Mobility of the Reader:

For example, this may consist of triggers related to initiation of, completion of, failure of, a mobility procedure (e.g., HO, reselection), or trigger of a failure procedure (e.g., RLF, reestablishment, etc.), or completion of a cell access after such procedure;
For example, a reader may have a specific behavior upon completion of a handover;
For example, a reader may have a specific behavior following access to cell after a reselection.

### Conditions Related to Properties of the Service, Such as:

Service type:
For example, this may consist of whether a service is associated with inventory only, or inventory+command;
For example, this may consist of whether a service is associated with a periodic request or non-periodic request by the network;
For example, this may consist of whether a service is as a result of NW request, or if it consists of WTRU autonomous transmission of available data.

### Service QoS:

For example, this may consist of a QoS marking, QoS value or set of values;
For example, this may consist of a priority level of data, of a response, of the reliability of the data transmitted/received by the service, etc.

### Required Service Latency:

For example, this may consist of the expected latency of a procedure, such as completion of the service, possibly to a specific level of satisfaction;
Expected response level of a service (or level of satisfaction):
For example, this may consist of the expected percentage of devices that are expected to have successfully responded to the service, from the number of devices in an area.
   Percentage of Known Devices that have Responded:
For example, this may consist of an expected percentage of the maximum number of devices that have responded to the service.

### Procedures Related to Triggering Paging Retransmission for a Service

### Reader Determining Number of Paging Rounds

According to embodiments, a reader WTRU may determine a number of paging rounds associated with a service request from the network and initiate such number of paging rounds following reception of the service request. In each paging round, for example, the reader may initiate a paging procedure on the AIOT interface whereby the paging message may use the same transaction ID.

In one embodiment, the number of paging rounds may be determined from the service type, service requirements, QoS, or similar information provided to the WTRU along with the service. In one example, a WTRU may be configured (e.g., by RRC) with a mapping of QoS marking (e.g., reliability) to number of paging rounds. When a reader WTRU receives a service request associated with a reliability, the WTRU may determine the configured number of paging rounds to initiate for the received reliability. The reader may then initiate (e.g., in sequence) the configured number of paging rounds before reporting the results to the network and/or terminating AIOT transmissions.

In another embodiment, the number of paging rounds may be determined by network indication. For example, the WTRU may receive an explicit number of paging rounds to initiate from the network (e.g., in RRC message, in MAC CE, etc). For example, the WTRU may receive the number of paging rounds to initiate for a given service implicitly. For example, the WTRU may determine the number of paging rounds based on the allocated AIOT resources (e.g. in time/frequency). Specifically, the reader may implicitly determine the number of paging rounds based on the number of resources which can be used for paging transmission.

### Reader Determining Whether to Initiate a Paging Retransmission for the Same Service

According to embodiments, a reader WTRU may determine whether to perform paging retransmission for a service following each paging (re) transmission for the service. The reader may make such determination successively following the completion of each paging round for the service.

In one embodiment, the reader may make such determination as a result of a request to the network. Specifically, the reader may transmit a message to the network (e.g., RRC message, MAC CE, etc.) following completion of a paging round (initial paging or paging retransmission) associated with a specific service. The message to the network may include results of the completed paging round, such as inventory results (e.g., device IDs, number of successful/completed command messages, number of responding devices, etc.), resource usage results (e.g., number of AIOT resources associated with D2R transmissions which were utilized), device transmission signal characteristics (e.g., received signal power of MSG1/MSG3, etc.), number of errors associated with the paging round (e.g., number of MSG3 decoding failures, number of MSG1 collisions, etc.). Following such message, the reader may receive an indication from the network of whether to initiate a new paging round for the same service or not. Specifically, reception of additional resources from the network following such transmission may indicate to the reader to initiate a paging retransmission for the same service.

In another embodiment, the reader may make such decision autonomously, based on configured conditions. For example, any or a combination of the following conditions may be used to trigger paging retransmission associated with the same service, possibly following completion of a paging round:
The number of devices that have responded in the paging round is below a threshold

The total number of devices that have responded to all paging rounds associated with the current service is larger than a threshold (e.g., configured by the network), is larger than a minimum number associated with the service, constitutes at least a configured percentage of the desired responses, is larger than a QoS/reliability dependent number or percentage, etc.

The number of failed MSG3 decodings (as described herein) in the previous paging round, in all paging rounds associated with the same service, etc. is larger than a threshold

The number of paging retransmissions already performed is larger than a threshold, or reaches a maximum value. Such maximum may further depend on other factors herein, such as QoS, latency, reliability, etc. associated with the service.

A reader may report the results of the service to the network following the last determined paging round.

Reader Determining the Number of Allowable Resources for Paging Round Associated with the Same Service

According to embodiments, a reader may determine, possibly following a specific paging round for a given service, the number of resources allowed for performance of a subsequent paging round associated with the same service. Specifically, the number of resources may consist of any of the following:
A (e.g., a maximum) number of access occasions (e.g., sync messages) associated with random access triggered by a paging message;
The (e.g., the maximum) number of time/frequency occasions which can be provided for D2R transmissions in the paging message associated with a paging round;
The (e.g., the maximum) allowable time period or duration for the paging round, possibly starting from the transmission by the reader of the paging message.

A reader may determine the number of resources based on explicit configuration by the network. Specifically, the reader may receive a number of resources from the network (e.g., in RRC, MAC CE, DCI) following a request to the network and/or indication to initiate a new paging round associated with the same service.

Alternatively, a reader may be configured with rules for determining the number of resources, which such rules may be based on any or a combination of the following:
Rules based on the number of resources used in the previous paging round. For example, a reader may use at most a factor X (e.g., preconfigured) of the resources in the previous round for the next round;
Rules based on the number of failures (e.g., MSG3 failures) in the previous round. For example, a reader may use at most a factor X (e.g., preconfigured) of the number of failures in the previous round for the number of resources in the next round. For example, a reader may use at least X (e.g., preconfigured) resources in the next round if the number of failures in the previous round is larger than Y (e.g., preconfigured). Otherwise, the reader must use less than X.

Rules based on the type of service, QoS of the service, reliability requirements of the service, etc., for example, a reader may use a first rule or condition herein to determine the number of resources in a paging round if the service has a first QoS, and may use a second rule or condition herein to determine the number or resources in a paging round if the service has a second QoS.

Number of paging rounds already performed for the service. For example, a reader may use at most X (e.g., configured) resources for the Nth (e.g., configured or predefined) paging round associated with the same service.

Rules based on the total number of devices which are expected to respond, have already responded, have not responded, or a percentage of such

### Contents of the Paging Retransmission Paging Message

A reader may provide information in the paging message that is specific to whether the transmission is an initial paging transmission, or a paging retransmission associated with a specific service ID.

In one embodiment, a reader may include an explicit indication of whether a paging message consists of the first paging message (first paging round) associated with a service or transaction ID. For example, a reader may include an indication or field (i.e., special control element) for the first paging transmission, and not include any such indication for subsequent transmissions. For example, a paging message may contain a specific bit field set to ‘0’ for the first paging transmission and set to ‘1’ for all subsequent paging transmissions associated with the same service.

In another embodiment, a reader may include some of the information associated with the service (e.g., inventory) only in the first paging message. For example, the reader may include the device IDs being paged in the first paging message associated with a service, and may not include such device IDs in the subsequent paging messages associated with the same service or same transaction ID. In another example, a reader may include the device IDs (or other service specific information) only in a subset of paging transmissions (e.g., every second repetition, e.g., in the first and last paging repetition, etc.). A device may trigger a re-access associated with a paging message reception by assuming the same information (e.g., device IDs) associated with the previous paging message received having the same transaction ID. Alternatively, a device which does not receive device IDs in a paging message (e.g., due to having missed the first paging message associated with a transaction ID, or having missed one of the paging messages which contained the device IDs) may always respond to the paging message (i.e., trigger random access) unless is previously responded successfully to a paging message send with the same transaction ID.

Procedures Related to Triggering Paging Retransmission Prior to Completion of an Inventory

According to embodiments, a reader may be configured with conditions for which it may initiate a new paging round or perform paging retransmission prior to completion of an inventory. For example, a reader may indicate a number of access occasions in the paging message of a specific paging round. Following such indication, a reader may transmit a paging message initiating a new paging round for the same service prior to transmission of all of the sync messages for each of the indicated access occasions.

A reader may initiate such a new paging round prematurely based on conditions herein. For example, if the number of MSG3 failures is above a threshold; if the received energy in a resource associated with MSG1 is larger than a threshold; if the number of detected MSG1 collisions is larger than a threshold.

A reader may initiate such new paging round prematurely based on indication by the network. Specifically, such may occur upon: Reception of an RRC message, MAC CE, DCI, etc., indicating to initiate premature paging round initiation; Occurrence of a mobility procedure, as discussed herein (e.g., following HO, reselection, access following mobility, etc.).

Procedures Related to Device Selection in an Access Occasion and/or Paging Round

In one embodiment, access and/or re-access for one or more specific devices may be signaled by the reader based on the status of a devices access, possibly in a previous paging round or access occasion. Specifically, a reader may indicate in an R2D message (e.g., the sync message indicating the start of an occasion, a paging message associated with paging retransmission, etc.) the specific devices to perform paging retransmission. For example, a reader may include, in the R2D message:
The random ID(s) of the devices which should perform re-access. Specifically, if a device selected a random ID and has not yet successfully completed access, the device may perform re-access following reception of a D2R message containing the specific random ID, or a group random ID which includes the specific random ID.

An indication that all devices which did not complete subsequent command procedure after inventory should initiate access. Specifically, if a device performed inventory associated with a transaction ID, but did not complete command procedure or did not receive command procedure, when the device receives a paging message with the same transaction ID and such indication, the device may initiate random access upon reception of the paging message;
An indication that all devices which currently have an AS ID assigned (or no AS ID assigned) may initiate random access. For example, if the reader includes such indication, devices which do not have a stored AS ID may initiate random access. For example, if the reader includes such indication in a paging retransmission, devices which do not have a stored AS ID but which have not completed an operation from a previous paging round associated with the same transaction ID may perform access.
   Procedures Triggering Access of Devices which have Run Out of Energy

A reader may trigger an access procedure targeted for devices which have released their AS ID prior to service completion. Specifically, a reader may initiate inventory followed by command. However, prior to completing a command procedure for one of the responding devices, such devices may run out of energy and release their AS ID.

In one embodiment, a reader may determine that a device to be addressed has released its AS ID based on a timer. For example, the reader may be configured with a maximum time period elapsed since initiation of an initial paging procedure (e.g., transmission of the first paging message associated with a service) from the initiation of a paging round (e.g., transmission of the specific paging message which triggered the device to respond to the random access), or from the time MSG1 was received by the device. If the period of time elapsed from the occurrence of one of the above has expired, and the reader has pending command messages to send to the device, the reader may initiate a paging procedure to trigger re-access by such device.

In one embodiment, a reader may indicate that it is triggering a re-access for the same service (as per herein) and include an indication that it is requesting access by devices which do not have a stored AS ID and/or did not perform successful command transmission in the last access round.

In one embodiment, a reader may determine the upper layer device ID of the device (e.g., received from MSG3 transmission) and may initiate a contention-free paging procedure associated with this device ID only.

In another embodiment, a reader may inform the network of the release of the AS ID by a device and/or the inability of the reader to issue a command to the device before expiry of the AS ID. Specifically, a reader may perform a command operation and/or retransmit a command for a specific device until the expiry of the timer described above. If the timer expires, the reader may stop transmission of a command for the specific device and report the device (e.g., the upper layer ID) to the network which have commands pending.

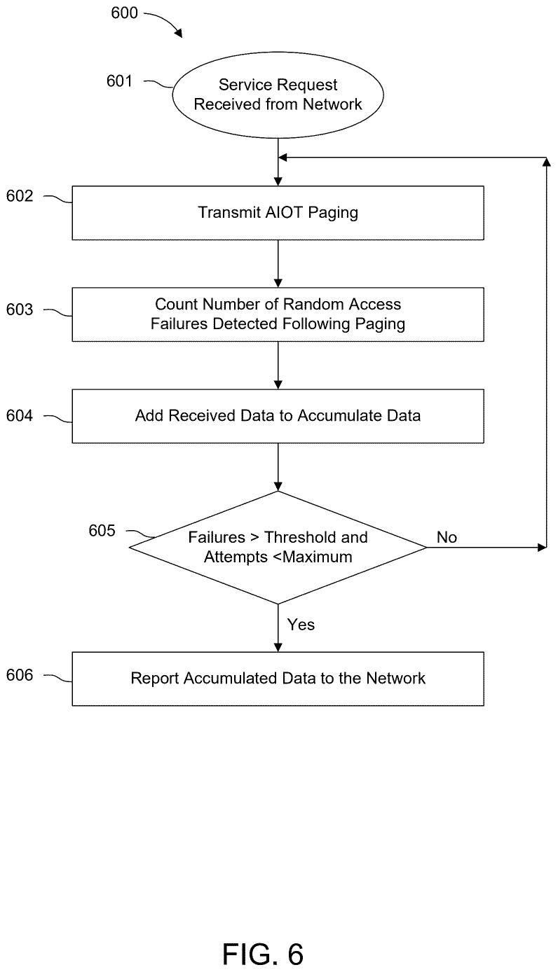

FIG. 6 is a flow chart of a method 600 of collection data from AIoT devices, implemented by a WTRU, the WTRU determining the number of paging rounds (i.e., transmission of paging followed by expected random access by multiple devices) to initiate for an inventory service request based on the number of decoding failures determined in a given paging round and the inventory reliability. The inventory service request is for example a CN request for a reader to collect information from/related to devices in a given area. The inventory service request may be for example initiated by the CN to obtain information about the number and/or identity of devices in a given area. Inventory and command service may consist of an inventory followed by sending r/w commands to devices).

The WTRU is configured with a set of reliability levels (e.g., levels 1, 2, 3, etc.) for an inventory service request. The WTRU is configured with a threshold number of failures for each inventory service request reliability level.

In 601, the method may comprise receiving (e.g., in an RRC message) an inventory service request comprising, for example, a reliability level; a maximum number of random-access procedures to be triggered for the service request; and a set of resources useable for AIOT transmissions to AIOT devices, and for reception of AIOT transmissions from AIOT devices. The WTRU determines a transaction ID from the received message. The transaction ID is for example a value of a counter that is incremented for each received service request.

In 602, the method may comprise transmitting a paging message (e.g., AIOT device paging) that initiates a random access of devices, the paging message containing an indication of the resources (e.g., number of occasions) for random access and the determined transaction ID.

In 603/604, the method may comprise receiving data (e.g., MSG3), from each of the devices that successfully perform random access in the indicated resources. Specifically, in 603 the method may comprise determining the number of devices which fail random access, where random access failure may be determined by: incorrect decoding of MSG3 and/or MSG3 not received following MSG2 transmission and/or failure to receive or decode command response following command transmission. Specifically, in 604, the method may comprise adding the received device IDs (i.e., contents of MSG3) to the list of distinct device IDs of devices which successfully completed the random access in the current paging round.

In 605, if the number of devices which fail random access is larger than the threshold number of failures associated with the received reliability level and the number of paging transmissions performed for the transaction ID is less than the maximum number of paging attempts, then:
(605—“No”): the method may comprise retransmitting the paging message to initiate another random-access procedure and collection of additional data with the determined transaction ID (i.e., return to 602). Then, devices that have already successfully performed RA in the indicated resources will not reply to the retransmitted paging message (as it has the same transaction ID of the previous transmitted paging message) while devices that did not successfully perform RA (or did not perform RA) in the indicated resources (e.g., because they were in an idle state, did not have enough energy harvested to be able to reply, etc.) may have an opportunity to reply to the retransmitted paging message by performing RA in the indicated resources.

Else (605—“Yes”): In 606, the method may comprise reporting the collected data for each random-access procedure initiated by the service request to the network (e.g., in an RRC message). The collected data may comprise e.g., data collected from a first set of devices following an initial transmission of the paging message and data collected from a second (third, fourth, etc.) set of devices following the repeated transmission(s) of the paging message.

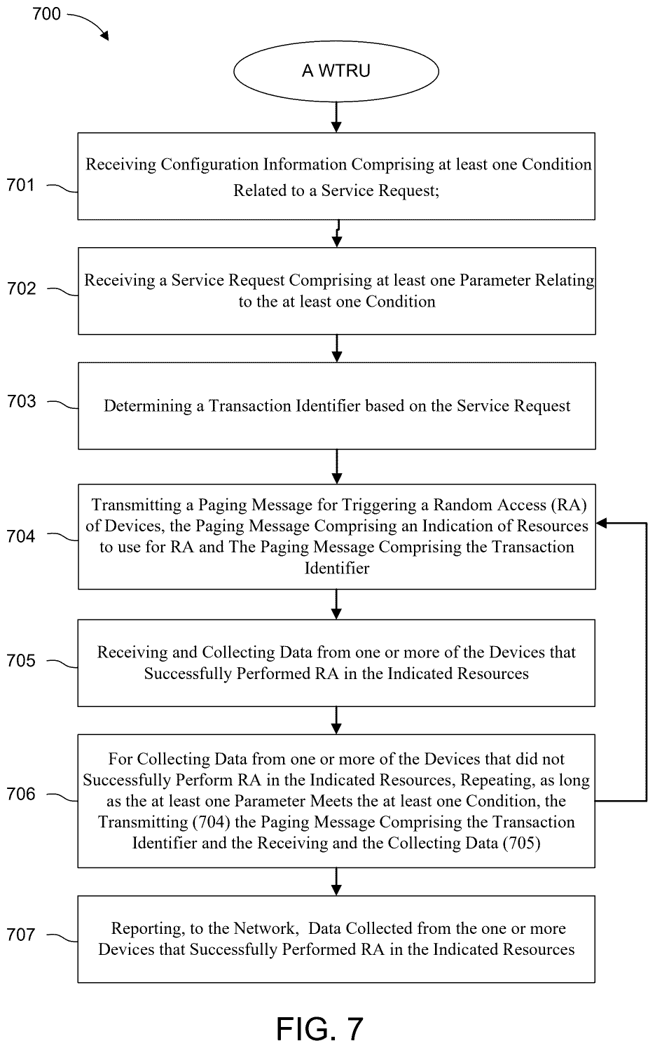

FIG. 7 is a flow chart of a method 700 according to an embodiment. The method may be implemented by a wireless transmit-receive unit (WTRU) in a network. The method may comprise:
Receiving (701) configuration information comprising at least one condition related to a service request;
Receiving (702) a service request comprising at least one parameter relating to the at least one condition;
Determining (703) a transaction identifier based on the service request;
Transmitting (704) a paging message for triggering a random access (RA) of devices, the paging message comprising an indication of resources to use for RA and the transaction identifier;
Receiving and collecting (705) data from one or more of the devices that successfully performed RA in the indicated resources;
(706) For collecting data from one or more of the devices that did not successfully perform RA in the indicated resources, repeating, as long as the at least one parameter meets the at least one condition, the transmitting the paging message comprising the transaction identifier and the receiving and the collecting data (i.e., repeating steps 704-705); and
Reporting (707), to the network, data collected from the one or more devices that successfully performed RA in the indicated resources.

According to an embodiment of the method, the at least one condition comprises a condition related to a threshold number of paging messages and the at least one parameter comprises a threshold number of paging messages, and wherein the at least one parameter meets the at least one condition as long as a number of paging messages transmitted is lower than the threshold number of paging messages.

According to an embodiment of the method, the at least one condition comprises a condition related to a threshold number of paging messages and a set of reliability levels, and per reliability level in the set of reliability levels an associated threshold number of failures to successfully perform RA, and wherein the at least one parameter meets the at least one condition as long as the number of failures for a configured reliability level is higher than the associated threshold number of failures and the number of paging messages transmitted is lower than the threshold number of paging messages.

According to an embodiment of the method, the transaction identifier may be determined from a counter that is incremented at each reception of an inventory service request.

According to an embodiment of the method, the indication of resources to use for RA is comprised in the inventory service request, and indicates a set of resources useable for ambient internet of things (AIOT) transmissions to AIOT devices, and for receipt of AIoT transmissions from AIOT devices.

According to an embodiment of the method, the indication of resources is a number of RA occasions.

According to an embodiment of the method, failure to successfully perform RA is determined from at least one of the following:
incorrect decoding by the WTRU, of a data message received (e.g., see FIG. 4, MSG3 (404));
failure to receive, by the WTRU, of a data message (e.g., FIG. 4, MSG3) in the indicated resources. E.g., if the WTRU (e.g., FIG. 4, 410) receives MSG1 (e.g., 402) following paging (e.g., 401), the AIoT device (e.g., 411) responds with MSG2 (e.g., 403) that contains a resource for the device that wins the contention to transmit MSG3 (e.g., 404). Absence of MSG3 in that resource is a failure.

There is also disclosed and described a wireless transmit-receive unit (WTRU) in a network, the WTRU comprising at least one processor configured to:
Receive configuration information comprising at least one condition related to a service request;
Receive a service request comprising at least one parameter relating to the at least one condition;
Determine a transaction identifier based on the service request;
Transmit a paging message for triggering a random access (RA) of devices, the paging message comprising an indication of resources to use for RA and the transaction identifier;
Receive and collect data from one or more of the devices that successfully performed RA in the indicated resources;
To collect data from one or more of the devices that did not successfully perform RA in the indicated resources, repeat, as long as the at least one parameter meets the at least one condition, transmitting the paging message comprising the transaction identifier and receiving and collecting data (i.e., repeat the above Transmit step and the Receive and collect data step); and
Report, to the network, data collected from the one or more devices that successfully performed RA in the indicated resources.

According to an embodiment, the at least one condition comprises a condition related to a threshold number of paging messages and the at least one parameter comprises a threshold number of paging messages, and wherein the at least one parameter meets the at least one condition as long as a number of paging messages transmitted is lower than the threshold number of paging messages.

According to an embodiment, the at least one condition comprises a condition related to a threshold number of paging messages and a set of reliability levels, and per reliability level in the set of reliability levels an associated threshold number of failures to successfully perform RA, and wherein the at least one parameter meets the at least one condition as long as the number of failures for a configured reliability level is higher than the associated threshold number of failures and the number of paging messages transmitted is lower than the threshold number of paging messages.

According to an embodiment, the at least one processor is configured to determine the transaction identifier from a counter that is incremented at each reception of an inventory service request.

According to an embodiment, the indication of resources to use for RA is comprised in the inventory service request, and indicates a set of resources useable for ambient internet of things (AIOT) transmissions to AIOT devices, and for receipt of AIoT transmissions from AIOT devices.

According to an embodiment, the indication of resources is a number of RA occasions.

According to an embodiment, the at least one processor is configured to determine failure to successfully perform RA from at least one of the following: incorrect decoding by the WTRU, of a data message received (e.g., MSG3); failure to receive, by the WTRU, of a data message (e.g., MSG3) in the indicated resources.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented by a wireless transmit-receive unit (WTRU) in a network, the method comprising:
receiving configuration information comprising at least one condition related to a service request;
receiving a service request comprising at least one parameter relating to the at least one condition;
determining a transaction identifier based on the service request;
transmitting a paging message for triggering a random access (RA) of devices, the paging message comprising an indication of resources to use for RA and the transaction identifier;
receiving and collecting data from one or more of the devices that successfully performed RA in the indicated resources;
for collecting data from one or more of the devices that did not successfully perform RA in the indicated resources, repeating, as long as the at least one parameter meets the at least one condition, the transmitting the paging message comprising the transaction identifier and the receiving and the collecting data; and
reporting, to the network, data collected from the one or more devices that successfully performed RA in the indicated resources.

2. The method of claim 1, wherein the at least one condition comprises a condition related to a threshold number of paging messages and the at least one parameter comprises a threshold number of paging messages, and wherein the at least one parameter meets the at least one condition as long as a number of paging messages transmitted is lower than the threshold number of paging messages.

3. The method of claim 1, wherein the at least one condition comprises a condition related to a threshold number of paging messages and a set of reliability levels, and per reliability level in the set of reliability levels an associated threshold number of failures to successfully perform RA, and wherein the at least one parameter meets the at least one condition as long as the number of failures for a configured reliability level is higher than the associated threshold number of failures and the number of paging messages transmitted is lower than the threshold number of paging messages.

4. The method of claim 1, wherein the transaction identifier is determined from a counter that is incremented at each reception of an inventory service request.

5. The method of claim 1, wherein the indication of resources to use for RA is comprised in the inventory service request, and indicates a set of resources useable for ambient internet of things (AIoT) transmissions to AIoT devices, and for receipt of AIoT transmissions from AIoT devices.

6. The method of claim 1, wherein the indication of resources is a number of RA occasions.

7. The method of claim 1, wherein failure to successfully perform RA is determined from at least one of the following:
incorrect decoding by the WTRU, of a data message received (MSG3);
failure to receive, by the WTRU, of a data message (MSG3) in the indicated resources.

8. A wireless transmit-receive unit (WTRU) in a network, the WTRU comprising at least one processor configured to:
receive configuration information comprising at least one condition related to a service request;
receive a service request comprising at least one parameter relating to the at least one condition;
determine a transaction identifier based on the service request;
transmit a paging message for triggering a random access (RA) of devices, the paging message comprising an indication of resources to use for RA and the transaction identifier;
receive and collect data from one or more of the devices that successfully performed RA in the indicated resources;
to collect data from one or more of the devices that did not successfully perform RA in the indicated resources, repeat, as long as the at least one parameter meets the at least one condition, transmitting the paging message comprising the transaction identifier and receiving and collecting data; and
report, to the network, data collected from the one or more devices that successfully performed RA in the indicated resources.

9. The WTRU of claim 8, wherein the at least one condition comprises a condition related to a threshold number of paging messages and the at least one parameter comprises a threshold number of paging messages, and wherein the at least one parameter meets the at least one condition as long as a number of paging messages transmitted is lower than the threshold number of paging messages.

10. The WTRU of claim 8, wherein the at least one condition comprises a condition related to a threshold number of paging messages and a set of reliability levels, and per reliability level in the set of reliability levels an associated threshold number of failures to successfully perform RA, and wherein the at least one parameter meets the at least one condition as long as the number of failures for a configured reliability level is higher than the associated threshold number of failures and the number of paging messages transmitted is lower than the threshold number of paging messages.

11. The WTRU of claim 8, wherein the at least one processor is configured to determine the transaction identifier from a counter that is incremented at each reception of an inventory service request.

12. The WTRU of claim 8, wherein the indication of resources to use for RA is comprised in the inventory service request, and indicates a set of resources useable for ambient internet of things (AIoT) transmissions to AIoT devices, and for receipt of AIoT transmissions from AIoT devices.

13. The WTRU of claim 8, wherein the indication of resources is a number of RA occasions.

14. The WTRU of claim 8, wherein the at least one processor is configured to determine failure to successfully perform RA from at least one of the following:
incorrect decoding by the WTRU, of a data message received (MSG3);
failure to receive, by the WTRU, of a data message (MSG3) in the indicated resources.
